(19) United States
(12) Patent Application Publication
(10) Pub. No.: US 2008/0180942 A1
(43) Pub. Date: Jul. 31, 2008

(54) Cabinet Lamp

(76) Inventor: David B. Hansen, Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/023,372

(22) Filed: Jan. 31, 2008

Related U.S. Application Data
(60) Provisional application No. 60/887,447, filed on Jan. 31, 2007.

(51) Int. Cl. F21V 33/00

(52) U.S. Cl. 362/133

(57) ABSTRACT

The system of the present invention provides this advantage by providing an elongated cabinet light having walls which are joined at an edge which engages a corner, shelf, top surface, side surface, or bottom surface of the cabinet. An illumination source is positioned within the walls defining the lamp housing and a light transmissive cover is placed across the free ends of the walls with a portion thereof provided diagonally to maximize the light output. The light can be mounted in the inside corner of the front of a cabinet adjacent the door. The light may include a lens extrusion flange which prevents viewing the cut edge of a cabinet shelf when the lamp unit extends between one or more shelves of the cabinet.

### CROSS REFERENCE TO RELATED APPLICATION

This application claims priority under 35 U.S.C. §119(e) to U.S. Provisional Application No. 60/887,447, filed on Jan. 31, 2007, the entire disclosure of which is incorporated herein by reference.

### BACKGROUND OF THE INVENTION

The present invention relates to a cabinet lamp and one which is adapted for mounting in the corner of a cabinet.

There exists a variety of aftermarket light fixtures that can be employed for the illumination of a cabinet. Such fixtures include flat, elongated fluorescent fixtures, which are typically mounted to the undersurface of a top shelf or other shelves of a cabinet to project light downwardly onto a lower shelf. Other aftermarket lighting accessories include lamp modules which mount to the side walls of a cabinet for providing illumination horizontally outwardly from the side wall. Such fixtures, although providing interior illumination for a cabinet, frequently interfere with the storage space available in the cabinet and can be easily bumped and damaged while placing items within a cabinet. There exists a need, therefore, for an improved cabinet lighting system in which illumination is provided to the interior of a cabinet in an efficient manner but one which does not interfere with storage or ingress and egress of items to and from the cabinet.

These and other features, advantages, and objects of the present invention will be further understood and appreciated by those skilled in the art by reference to the following specification, claims, and appended drawings.

### SUMMARY OF THE INVENTION

The system of the present invention provides this advantage by providing an elongated cabinet light having walls which are joined at an edge which may engage a corner of the cabinet. Illumination means is positioned within the walls defining the lamp housing and a light transmissive cover is placed across the free ends of the walls and has at least one portion that is diagonal relative to the walls to maximize the light output.

According to one aspect of the present invention, a cabinet light is provided for the illumination of the interior of a cabinet. The cabinet light comprising: an elongated housing having a pair of intersecting walls coupled to each other along one edge and having opposed free edges, wherein at least one of the walls includes mounting structure for attaching the at least one wall to a surface of a cabinet adjacent a corner, an interior bottom surface of the cabinet, an interior top surface of the cabinet, interior side surfaces, or at least one shelf of the cabinet; a source of illumination coupled to the housing; and a light transmissive cover extending between the walls adjacent the free edges for directing illumination outwardly from the housing along a substantial section of the elongated housing, at least a portion of the cover extending diagonally relative to the walls.

According to another aspect of the invention, a cabinet including a light is provided for the illumination of the interior of the cabinet. The cabinet/light combination comprising: a cabinet having a pair of intersecting surfaces defining a corner; an elongated housing having a pair of walls coupled to each other along one edge and having opposed free edges, wherein the walls intersect at generally the same angle as the surfaces and wherein at least one of the walls includes mounting structure for attaching the at least one wall to a surface of the cabinet adjacent the corner; a source of illumination coupled to the housing; and a light transmissive cover extending between the walls adjacent the free edges for directing illumination outwardly from the housing along a substantial section of the elongated housing, at least a portion of the cover extending diagonally relative to the walls. The pair of intersecting surfaces may include a side panel and a front panel of the cabinet.

According to another aspect of the invention, a cabinet including a light is provided for the illumination of the interior of the cabinet. The cabinet/light combination comprising: a cabinet having an interior bottom surface, an interior top surface, interior side surfaces, and at least one shelf; an elongated housing having a pair of walls coupled to each other along one edge and having opposed free edges, wherein at least one of the walls includes mounting structure for attaching to at least one of the interior bottom surface, interior top surface, interior side surfaces, or one of the at least one shelf of the cabinet; a source of illumination coupled to the housing; and a light transmissive cover extending between the walls adjacent the free edges for directing illumination outwardly from the housing along a substantial section of the elongated housing, at least a portion of the cover extending diagonally relative to the walls.

According to other aspects of the invention, the light transmissive cover may include transmissive portions and opaque portions, the opaque portions provided to block light from projecting directly towards a door of the cabinet. The light transmissive cover may be formed from an extruded piece of plastic.

According to other aspects of the invention, the housing may extend generally horizontally or vertically within the cabinet. The cabinet may include at least one horizontally extending shelf having an aperture therethrough where the housing extends through the aperture such that light from the source of illumination illuminates opposite sides of the shelf. The aperture may be formed in a front corner of the shelf and the light is mounted so as to project light toward the back of the cabinet. The light transmissive cover may include a flange that extends outward to cover a cut edge of the shelf.

The source of illumination may include a circuit board disposed in substantially parallel spaced relationship to the cover. Additionally, the source of illumination may comprises a plurality of lamps (which may be light emitting diodes) positioned in spaced relationship on the circuit board.

The light may further include a heat sink thermally coupled to the source of illumination. The heat sink may be formed from an integral extrusion and may comprise a support member having a planar surface that is diagonally disposed relative to the walls of the housing, where the planar surface configured to accommodate and secure a circuit board on which the source of illumination is mounted. The heat sink may further include a plurality of fins extending from an opposite side of the support member from the planar surface, the fins including a middle fin that extends further from the support member than other ones of the plurality of fins. The heat sink may also include a pair of arms that extend from opposing edges of the support member in an opposite direction than the fins, the pair of arms tabs for engaging and securing the cover.

The light may further comprises a pair of cover caps secured to opposite ends of the light. The cover caps comprise vent holes formed through the cover caps to allow heat to escape. The cover caps may comprise a wiring hole for wiring to pass into the light for supplying power to the source of illumination. The cover caps may comprise integrated latches for snapping onto the light.

It is to be understood that the foregoing description is exemplary of the invention only and is intended to provide an overview for the understanding of the nature and character of the invention as it is defined by the claims. The accompanying drawings are included to provide a further understanding of the invention and are incorporated and constitute part of this specification. The drawings illustrate various features and embodiments of the invention, which, together with their description serve to explain the principals and operation of the invention.

### BRIEF DESCRIPTION OF THE DRAWINGS

In the drawings:

FIG. 1 is a perspective view of one embodiment of the light assembly installed in a cabinet, shown extending through a cabinet shelf so as to illuminate two areas of the cabinet;

FIG. 2 is a front elevational view of the light assembly shown in FIG. 1;

FIG. 3 is a top plan view of the light assembly shown in FIGS. 1 and 2;

FIG. 4 is a cross-sectional view of the light assembly, taken along section line IV-IV of FIG. 3;

FIG. 5 is a cross-sectional view of the light assembly, taken along section line V-V of FIG. 3;

FIG. 6 is a cross-sectional view of the light assembly, taken along section line VI-VI of FIG. 2;

FIG. 7 is a front elevational view of a cabinet showing various positions to which the cabinet light may be mounted within the cabinet;

FIG. 8 is a perspective view of another embodiment of the light assembly installed in a cabinet, shown extending through a cabinet shelf so as to illuminate two areas of the cabinet; and

FIG. 9 is a cross-sectional view of the light assembly, taken along section line IX-IX of FIG. 8.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numerals will be used throughout the drawings to refer to the same or like parts.

For purposes of description herein, the terms “upper,” “lower,” “right,” “left,” “rear,” “front,” “vertical,” “horizontal,” “top,” “bottom,” and derivatives thereof shall relate to the invention as shown in the drawings. However, it is to be understood that the invention may assume various alternative orientations, except where expressly specified to the contrary. It is also to be understood that the specific devices illustrated in the attached drawings and described in the following specification are simply exemplary embodiments of the inventive concepts defined in the appended claims. Hence, specific dimensions, proportions, and other physical characteristics relating to the embodiment disclosed herein are not to be considered as limiting, unless the claims expressly state otherwise.

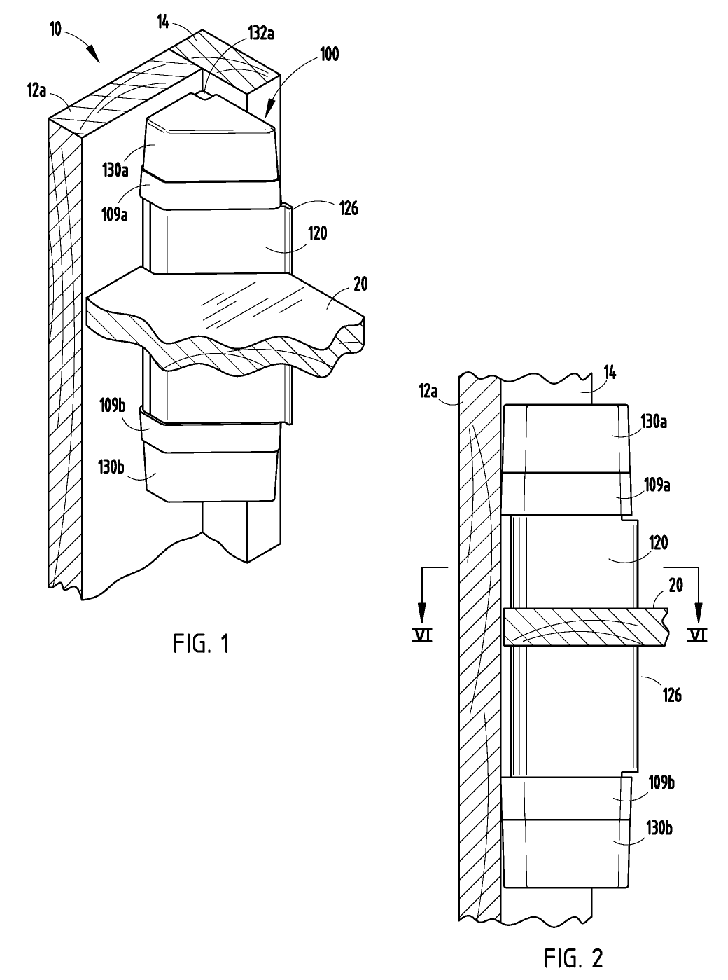

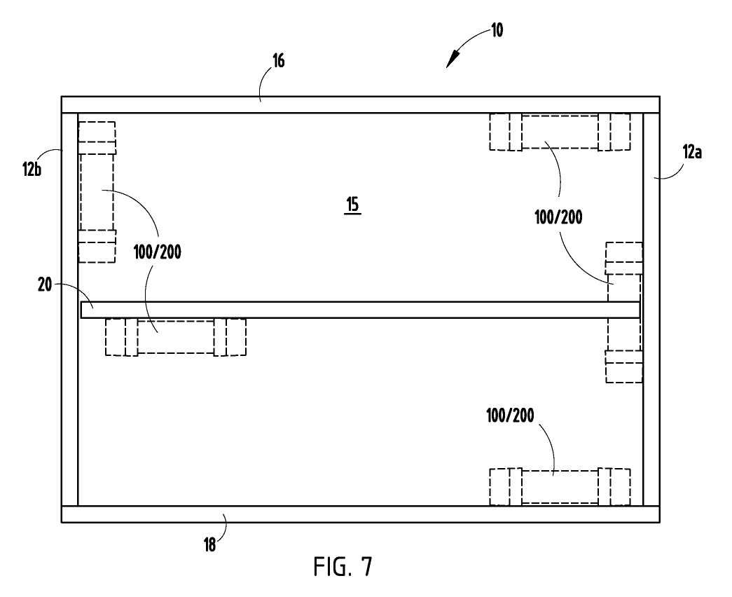

The embodiments of a light 100 and 200 are shown herein as being mounted on the inside of a cabinet 10. As best shown in FIGS. 1 and 7, a typical cabinet 10 may include: a first side panel 12a, a second side panel 12b, which extends in parallel with first side panel 12a; a top panel 16 that extends between the top edges of side panels 12a and 12b; a bottom panel 18 that extends along the bottom edges of side panels 12a and 12b; and an optional rear panel 15 that may be generally perpendicular to all the aforementioned panels so as to extend between the rear edges of all four panels. It should be noted, however, that in the event the cabinet is mounted in a corner, additional side/rear panels may be provided. In general, it is intended that lights 100 and 200 may be mounted within any cabinet. Such cabinets may further include one or more shelves 20 that extend parallel to the top panel 16 and bottom panel 18. Further, as shown in FIG. 1, the cabinet may include front panels 14 which generally extend between the front edges of panels 12a, 12b, 16, and 18 and which define one or more openings that are accessible by opening one or more doors (not shown). It should be noted that some cabinets are constructed that do not include front panels 14.

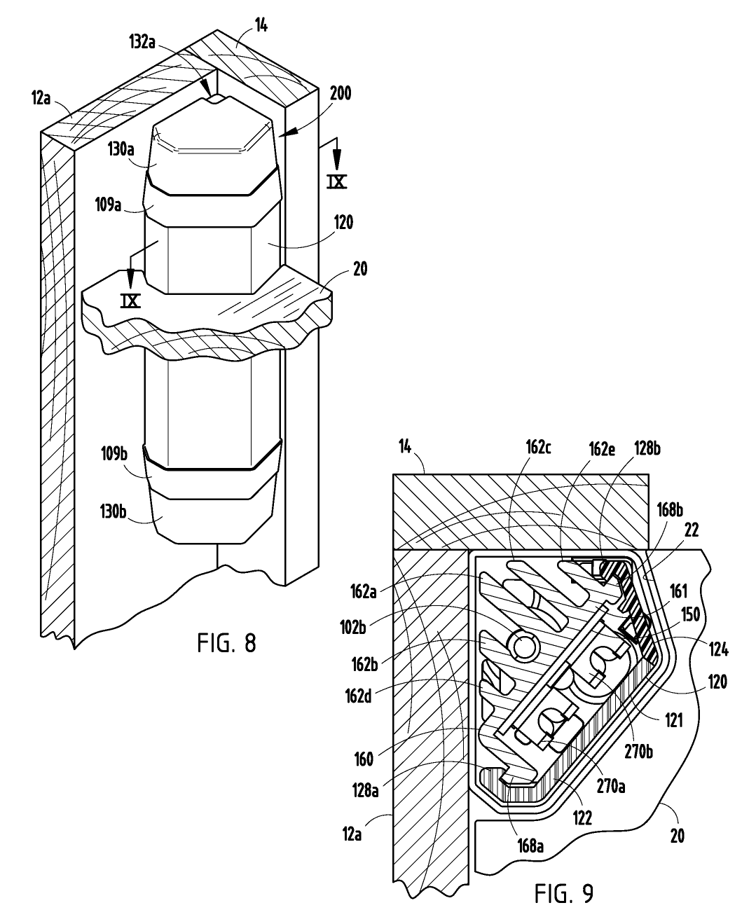

As shown in FIG. 7, light 100/200 may be mounted to an interior bottom surface of bottom panel 18, and interior top surface of top panel 16, interior side surface of either of side panels 12a and 12b, or to any surface of a shelf 20. In addition, the light fixture may be mounted to an interior surface of rear panel 15 or an interior surface of front panel 14. Moreover, as shown in FIGS. 1 and 8, light 100/200 may be mounted in a corner formed by any two of the aforementioned surfaces. In the particular embodiments shown and discussed in the remaining portion of the application, lights 100 and 200 are mounted in a front corner to the inside surfaces of a side panel 12a and front panel 14. Although the lights may extend horizontally (as shown in FIG. 7), the embodiments discussed below show the lights mounted vertically. The lights could also be mounted externally to the cabinet for above- or below-cabinet lighting.

As also shown in the disclosed embodiments, the lights may be mounted to extend through a plane in which a shelf 20 is disposed. In this case, an aperture 22 may be cut or otherwise formed in the front corner of shelf 20 as best shown in FIGS. 1 and 8. This enables lights 100 and 200 to project light substantially rearward in the cabinet both above and below a shelf 20. This may eliminate the need for a separate light fixture to be provided both above and below each shelf 20. As will be described further below, each of lights 100 and 200 includes a light transmissive cover having at least one surface that is disposed diagonally relative to the corner in which the light is mounted so as to efficiently project the light throughout the interior of the cabinet.

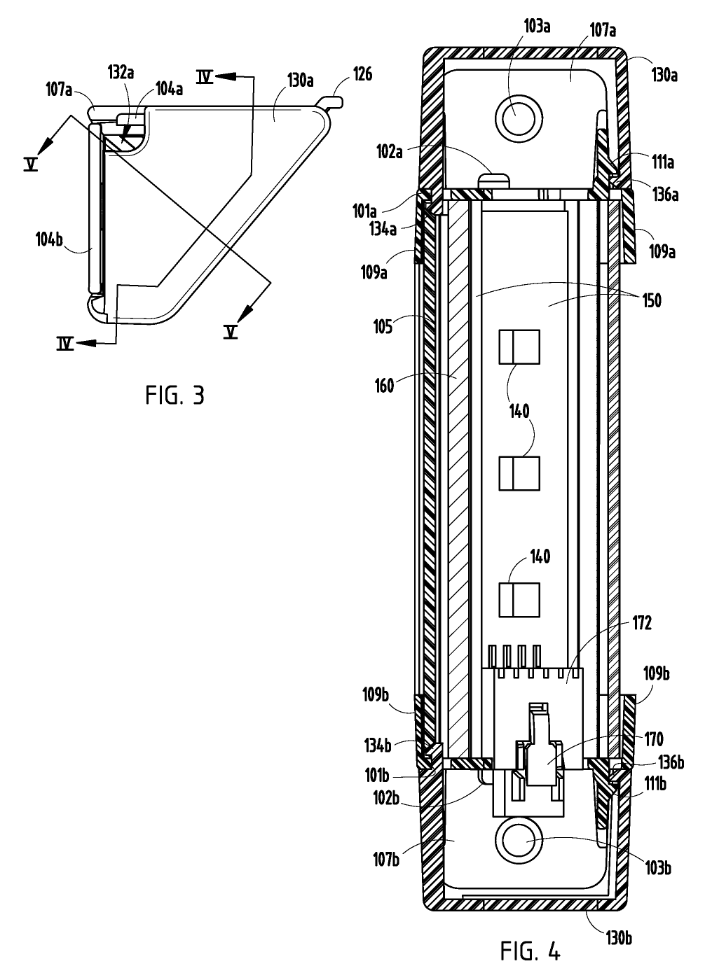

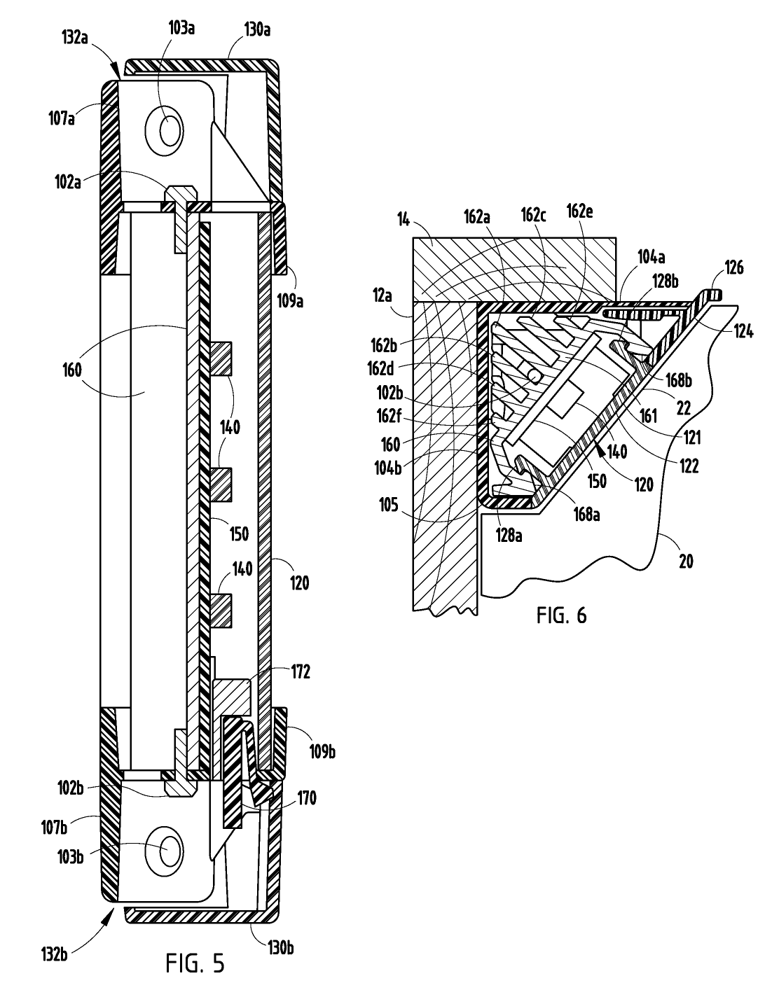

With reference to FIGS. 1-6, a first embodiment of the present invention will now be described. As shown in FIGS. 1 and 2, light 100 includes an elongated housing 105 (see FIGS. 3-6) and a pair of mounting caps 107a and 107b disposed at opposite ends of housing 105. The mounting caps 107a and 107b may include respective flanges 109a and 109b which extend towards one another around the outer periphery of the light to conceal the edges of housing 105 and a light transmissive cover 120 which both extend between mounting caps 107a and 107b. In addition, light 100 may include a first cover cap 130a and a second cover cap 130b that are attached to opposite ends of the light, as further described below.

FIGS. 4, 5, and 6 show that light 100 may further comprise a source of illumination which may include a plurality of lamps, or more particularly (as illustrated) a plurality of light emitting diodes (LEDs) 140 that are spaced apart and mounted to a mounting member, which may be a circuit board 150. Circuit board 150 may be mounted to a heat sink 160. In general, heat sink 160 and cover 120 are formed by extrusion-meaning that they have an identical cross-section to that illustrated in FIG. 6 along their entire length. By forming the heat sink 160 and the cover 120 in this fashion, lights 100 may be readily constructed with varying lengths. In particular, one would only need to cut the lengths longer or shorter and provide different circuit boards with differing amounts of LEDs 140 to change the length of the light given the remaining construction. Housing 105 may similarly be a single extruded piece.

Having generally described most of the components of light 100, a detailed description of the various components is provided below. It should be understood that such detailed descriptions are not intended to limit the invention.

As shown in the Figures, housing 105 comprises side walls 104a and 104b that intersect at an angle of about 90 degrees. It will be appreciated, however, that this angle may vary, particularly depending upon the angle at which the intersecting panels of the cabinet meet.

Cover 120 may be configured to have at least one portion-namely, surface 121, that extends diagonally relative to side walls 104a and 104b of housing 105. Light transmissive cover 120 may also include both transmissive portions 122 and opaque or less transmissive portions 124, which are provided to block light from projecting directly towards the door of the cabinet or in other directions that are not particularly desirable. Cover 120 is preferably made of a plastic material and may include integral ridging, lenses, or diffusers to most effectively project the light for a particular application.

If light 100 is provided so as to pass through an aperture 22 in a shelf 20 as shown in FIGS. 1, 2, and 6, cover 120 may include a flange 126 that extends outward from a corner of cover 120 so as to hide the cut in the shelf 20 for forming aperture 22. Such a cut would otherwise be visible by a person looking into the cabinet.

As best shown in FIG. 6, cover 120 may include tabs 128a and 128b that extend inward so as to engage mating tabs 168a and 168b, respectively, of heat sink 160. This may allow the cover to be snapped into the heat sink 160 or it may be slid lengthwise into engagement with heat sink 160 prior to attaching mounting caps 107a and 107b.

Heat sink 160 may include a support member 161 that has a generally planar surface to which circuit board 150 may be mounted. Mounting of the circuit board 150 to the surface of support member 161 may be by any conventional means so as to provide the most efficient thermal coupling of the heat sink to the circuit board. Heat sink 160 further includes the aforementioned tabs or arms 168a and 168b that extend towards cover 120 from opposite edges of support member 161. As described above, these arms or tabs 168a and 168b are provided to engage corresponding tabs 128a and 128b of cover 120. As shown in FIG. 6, it is preferable that support member 161 is configured such that the planar surface on which circuit board 150 is mounted is substantially parallel to the diagonal surface 121 of cover 120. This allows the LEDs 140 to be mounted flush with the circuit board 150 which aids in the thermal conduction from the LEDs 140 to the heat sink 160. In addition, this allows the LEDs to be generally aimed to project light perpendicularly through the diagonal surface 121 of cover 120. In the embodiment illustrated in the drawings, the diagonal surface 121, circuit board 150, and planar surface of support member 161 are at approximately 45 degrees relative to the side panel 12a and front panel 14 of cabinet 10. Other angles may be appropriate for different cabinets or effects.

Heat sink 160 is preferably formed of an extruded metal, such as aluminum, that has good heat conduction properties while also providing sufficient structural rigidity so as to provide the primary internal support for the light. More particularly, mounting caps 107a and 107b would represent the only other primary means for support in that they are both formed of metal or other rigid material and include apertures 103a and 103b through which screws may be used to mount the light to the cabinet. Mounting caps 107a and 107b may be attached to opposite ends of the extruded heat sink 160 by means of respective screws 102a and 102b. As shown in FIG. 6, screws 102a and 102b may engage heat sink 160 between the parallel fins 162 that extend from support member 161 in a direction opposite that of which the light is generally projected.

In the embodiment illustrated in FIG. 6, the heat sink comprises a first middle fin 162a which is the longest of the fins and which extends closest to the interior corner formed by side walls 104a and 104b of housing 105. Additional fins 162b, 162c, 162d, 162e, and 162f extend in parallel to first fin 162a but have shorter lengths due to the angular positioning of heat sink 160 within housing 105 relative to side walls 104a and 104b. These fins extend down the length of heat sink 160, particularly if heat sink 160 is extruded. In the embodiment shown where light 100 is mounted vertically, it may be beneficial to have the fins extend vertically from heat sink 160 such that hot air may readily move upward between the fins and then out of the device. It may nevertheless be possible that if it is known that the light will be mounted horizontally, the fins would extend perpendicular to the direction in which they are shown as to extend in FIG. 6. Such an arrangement, however, would not enable the heat sink 160 to be extruded.

As shown in FIGS. 1, 3, and 5, cover caps 130a and 130b may include one or more holes 132a and 132b, respectively, to allow wiring to pass therethrough and/or provide holes for venting the hot air dissipating from the heat sink 160. Any hole 132a or 132b provided for the wiring, is preferably positioned at the corner of the cover cap that is closest to the corner of the cabinet such that the wiring may be run in a manner that is hidden within the cabinet corner. Cover caps 130a and 130b may be formed of any material and may specifically be formed of a plastic material. Mounting caps 107a and 107b are preferably plastic, but may be formed of a metal to provide further means of heat sinking. Mounting caps 107a and 107b preferably include apertures so as to not internally seal off the ends of heat sink 160, but otherwise to allow sufficient venting of the air across the fins of the heat sink.

The cover caps 103a and 103b preferably include integral latches 134a, 134b, 136a, and 136b that allow the cover caps 130a and 130b to be snapped in place. As illustrated, the latches 134a and 134b of cover caps 130a and 130b pass through apertures 101a and 101b provided through an internal surface of mounting caps 107a and 107b respectively. It should be noted however, that the latches 134a and 134b may otherwise latch to mounting caps 107a and 107b without passing through any apertures. Latches 136a and 136b of cover caps 130a and 130b are configured to engage respective tabs 111a and 111b of respective mounting caps 107a and 107b.

Circuit board 150 may be any conventional circuit board, but preferably is a FR4 circuit board or a metal clad circuit board so as to optimize the transmission of heat from the LEDs 140 to heat sink 160.

The LEDs are preferably LUMILED REBEL LEDs, which emit a warm white light. It should be appreciated, however, that other LEDs may be used depending upon the color temperature or color that one wishes to project.

With the construction discussed above, the circuit board 150 with light sources 140 mounted thereon, may be first attached to heat sink 160 and then cover 120 may be attached to heat sink 160. Housing 105 may optionally be attached to heat sink 160 or otherwise temporarily held in place. Once housing 105, heat sink 160, and cover 120 are generally positioned together, mounting caps 107a and 107b may then be attached to the respective ends of heat sink 160 by means of screws 102a and 102b. By attaching the mounting caps 107a and 107b to the heat sink 160, the flanges 109a and 109b serve as collars that extend around the outer peripheries of cover 120 and housing 105 further holding these components in place. One would then secure light 100 to cabinet 10 by utilizing screws through holes 103a and 103b provided in mounting caps 107a and 107b, respectively. Once this is completed, one would connect the end of a power supply wire connector 170 into a mating receptacle 172 that is electrically coupled to circuit board 150. Once the steps are completed, cover caps 130a and 130b may be snapped in place on mounting caps 107a and 107b for aesthetic purposes. As one will then see, the primary mechanical support for light 100 is provided by the combination of mounting caps 107a and 107b and heat sink 160. It should be appreciated, however, that other forms of support may be provided within light 100.

A second embodiment of a light 200 according to a second embodiment is shown in FIGS. 8 and 9. Light 200 is similar to light 100 with the exception that a portion of diagonal surface 100 of cover 120, particularly that portion 124 which is opaque, is truncated. This truncation is provided so that no portion of light 200 extends beyond the opening defined by the front panel 14 of the cabinet. As shown, the cut edge of the shelf may be provide so as to be positioned behind the peripheral edge of front panel 14 thereby eliminating the need for a flange 126 such as that provided in the first embodiment.

An additional difference is that instead of including a plug-type connector 172, insulation displacement terminals 270a and 270b may be provided such that the insulated wires that run to the lights need not include connectors 170. Such insulation displacement terminals 270 would allow one to simply push the insulated wires down into the openings of the terminals which would cut through the insulation and make electrical contact with the metal wire within the insulated wire. In addition to these connection means, other types of connectors or terminals located on circuit board 150 could also serve the purpose of making electrical connections to the power supply and other identical lamps in series or in parallel.

In the example shown in FIG. 9, the hole cut in shelf 22 is large enough to allow light 200 including flanges 109a and 109b of cover caps 130a and 130b to be slid therethrough. It will be appreciated, however, that the hole in shelf 22 may be smaller to more closely fit around cover 120 with the tradeoff that the cover caps would not be able to slide through the hole. It should also be noted that in FIG. 9, the thickness of flange 109b of cover cap 130b is shown as being thinner than cover 120. It may be preferable to make the cover cap as thick as cover 120 and also to provide space for housing 105 between flange 109b and heat sink 160.

Lights 100 and 200 may be activated by a cabinet-mounted switch provided at the opening of the cabinet such that the opening of the door actuates the light, or by a manually, conventionally placed separate switch.

The above description is considered that of the preferred embodiment only. Modifications of the invention will occur to those skilled in the art and to those who make or use the invention. Therefore, it is understood that the embodiment shown in the drawings and described above is merely for illustrative purposes and not intended to limit the scope of the invention, which is defined by the following claims as interpreted according to the principles of patent law, including the doctrine of equivalents.

The invention claimed is:

1. A cabinet light for the illumination of the interior of a cabinet comprising:
an elongated housing having a pair of intersecting walls coupled to each other along one edge and having opposed free edges, wherein at least one of said walls includes mounting structure for attaching said at least one wall to a surface of a cabinet adjacent a corner, an interior bottom surface of the cabinet, an interior top surface of the cabinet, interior side surfaces, or at least one shelf of the cabinet;
a source of illumination coupled to said housing; and
a light transmissive cover extending between said walls adjacent said free edges for directing illumination outwardly from said housing along a substantial section of the elongated housing, at least a portion of said cover extending diagonally relative to said walls.

2. The light of claim 1, wherein said light transmissive cover includes transmissive portions and opaque portions, said opaque portions provided to block light from projecting directly towards a door of the cabinet.

3. The light of claim 1, wherein said light transmissive cover includes a flange that extends outward to cover a cut edge of a shelf of the cabinet.

4. The light of claim 1 wherein said source of illumination includes a mounting member coupled to said walls in substantially parallel spaced relationship to said cover.

5. The light of claim 4 wherein said source of illumination comprises a plurality of lamps positioned in spaced relationship on said mounting member.

6. The light of claim 4 wherein said mounting member comprises a circuit board and said source of illumination comprises a plurality of light emitting diodes mounted in spaced relationship on said circuit board.

7. The light of claim 1 and further including a heat sink thermally coupled to said source of illumination.

8. The light of claim 7, wherein said heat sink is an extrusion.

9. The light of claim 7, wherein said heat sink comprises:
a support member having a planar surface that is diagonally disposed relative to said walls, said planar surface configured to accommodate and secure a circuit board on which said source of illumination is mounted; and
a plurality of fins extending from an opposite side of said support member from said planar surface, said fins including a middle fin that extends further from said support member than other ones of said plurality of fins.

10. The light of claim 9, wherein said heat sink further comprises a pair of arms that extend from opposing edges of said support member in an opposite direction than said fins, said pair of arms tabs for engaging and securing said cover.

11. The light of claim 1 wherein said walls intersect at an angle of about 90°.

12. The light of claim 1 wherein said light transmissive cover is formed from an extruded piece of plastic.

13. The light of claim 1 and further comprising a pair of cover caps secured to opposite ends of said light.

14. The light of claim 13, wherein said cover caps comprise vent holes formed through said cover caps to allow heat to escape.

15. The light of claim 13, wherein one of said cover caps comprise a wiring hole for wiring to pass into the light for supplying power to said source of illumination.

16. The light of claim 13, wherein said cover caps comprise integrated latches for snapping onto said light.

17. A cabinet including a light for the illumination of the interior of said cabinet comprising:
a cabinet having a pair of intersecting surfaces defining a corner;
an elongated housing having a pair of walls coupled to each other along one edge and having opposed free edges, wherein said walls intersect at generally the same angle as said surfaces and wherein at least one of said walls includes mounting structure for attaching said at least one wall to a surface of said cabinet adjacent said corner;
a source of illumination coupled to said housing; and
a light transmissive cover extending between said walls adjacent said free edges for directing illumination outwardly from said housing along a substantial section of the elongated housing, at least a portion of said cover extending diagonally relative to said walls.

18. The cabinet of claim 17, wherein said housing extends generally vertically within said cabinet.

19. The cabinet of claim 18, wherein said cabinet includes at least one horizontally extending shelf having an aperture therethrough and wherein said housing extends through said aperture such that light from said source of illumination illuminates opposite sides of said shelf.

20. The cabinet of claim 19, wherein said aperture is formed in a front corner of said shelf and said light is mounted so as to project light toward the back of said cabinet.

21. The cabinet of claim 20, wherein said pair of intersecting surfaces include a side panel and a front panel of said cabinet.

22. The cabinet of claim 19, wherein said light transmissive cover includes a flange that extends outward to cover a cut edge of said shelf.

23. The cabinet of claim 17, wherein said light transmissive cover includes transmissive portions and opaque portions, said opaque portions provided to block light from projecting directly towards a door of the cabinet.

24. The cabinet of claim 17, wherein said source of illumination includes a circuit board secured in parallel spaced relationship to said cover.

25. The cabinet of claim 24, wherein said source of illumination comprises a plurality of light emitting diodes mounted in spaced relationship on said circuit board.

26. The cabinet of claim 24 and further including a heat sink thermally coupled to said circuit board.

27. The cabinet of claim 26, wherein said cover snap fits onto said heat sink.

28. A cabinet including a light for the illumination of the interior of said cabinet comprising:
a cabinet having an interior bottom surface, an interior top surface, interior side surfaces, and at least one shelf;
an elongated housing having a pair of walls coupled to each other along one edge and having opposed free edges, wherein at least one of said walls includes mounting structure for attaching to at least one of said interior bottom surface, interior top surface, interior side surfaces, or one of said at least one shelf of said cabinet;
a source of illumination coupled to said housing; and
a light transmissive cover extending between said walls adjacent said free edges for directing illumination outwardly from said housing along a substantial section of the elongated housing, at least a portion of said cover extending diagonally relative to said walls.

29. The cabinet of claim 28 wherein said housing extends generally vertically within said cabinet.

30. The cabinet of claim 29, wherein said cabinet includes at least one horizontally extending shelf having an aperture therethrough and wherein said housing extends through said aperture such that light from said source of illumination illuminates opposite sides of said shelf.

31. The cabinet of claim 30, wherein said aperture is formed in a front corner of said shelf and said light is mounted so as to project light toward the back of said cabinet.

32. The cabinet of claim 30, wherein said light transmissive cover includes a flange that extends outward to cover a cut edge of said shelf.

33. The cabinet of claim 28, wherein said light transmissive cover includes transmissive portions and opaque portions, said opaque portions provided to block light from projecting directly towards a door of the cabinet.

34. The cabinet of claim 28 wherein said source of illumination includes a circuit board in parallel spaced relationship to said cover.

35. The cabinet of claim 34 wherein said source of illumination comprises a plurality of lamps positioned in spaced relationship on said circuit board.

36. The cabinet of claim 35 and further including a heat sink thermally coupled to said circuit board.

37. The cabinet of claim 34 wherein said source of illumination further comprises a plurality of light emitting diodes mounted in spaced relationship on said circuit board.
